(19) United States
(12) Patent Application Publication
(10) Pub. No.: US 2008/0000719 A1
(43) Pub. Date: Jan. 3, 2008

(54) SUSPENSION RELIEF DEVICE AND METHOD OF USE THEREOF

(76) Inventor: Dennis K. JONES, Huntsville, AL (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/771,357

(22) Filed: Jun. 29, 2007

Related U.S. Application Data
(60) Provisional application No. 60/806,133, filed on Jun. 29, 2006.

(51) Int. Cl. A62B 1/16; A62B 35/00

(52) U.S. Cl. 182/3

(57) ABSTRACT

A suspension relief device and method of use for minimizing suspension trauma to a user suspended in a harness in an elevated position in which the user's legs are dangling beneath the user's heart. The suspension relief device attaches to the user's harness and includes a strap for providing a foothold for the user's feet and a sliding loop for adjusting the length of the strap.

### CROSS REFERENCE TO RELATED APPLICATIONS

This application claims priority to U.S. Provisional Patent Application Ser. No. 60/806,133, filed Jun. 29, 2006, which is hereby incorporated herein by reference in its entirety for all purposes.

### FIELD OF THE INVENTION

The present invention relates generally to safety equipment and methods, and more particularly to a suspension relief device and method of use therefor for a user suspended from a safety line.

### BACKGROUND OF THE INVENTION

Many activities require a participant to take an elevated position above the ground and to climb to and descend from that elevated position. For example, hunters, wildlife photographers, and other sportsmen often position themselves in elevated tree stands many feet above the ground. Linesmen and maintenance workers also must access elevated equipment for repair and installation purposes. These activities present the risk of injury if the participant falls from the elevated position.

Various safety practices and equipment have been developed to reduce the risk of injury from falls during elevated activities. For example, a variety of safety belts and harnesses are known. These devices typically engage portions of the wearer's body and permit the wearer to attach a safety line between the harness or belt and some elevated structure. In the event of a fall, the wearer will not fall to the ground, but instead will only fall as far as the safety line's length will permit. Thus, the user of the safety line will be suspended by the line.

Once suspended, the weight of the user is supported by the straps of the harness that typically wrap around the user's upper thighs, which can result in significant discomfort to the user. Additionally, sometimes the person has a limited amount of time, as little as five minutes, to be rescued before risking his health and life. Generally, when a person falls and is suspended by a safety line, he is suspended in a generally upright position with his feet generally dangling below his heart. When suspended for a period of time in this position, blood begins to pool in the veins of the person's lower extremities because gravity pulls blood downwardly into the legs and because veins stretch and distend. Such pooling of blood in a person's lower extremities can be fatal because the blood does not generally circulate back into the heart to be oxygenized and pumped out to the rest of the body. Though the heart tends to beat faster to try to deliver blood to the brain and other critical organs, such faster beating can be ineffective if not enough blood is returned to the heart. This condition is generally referred to as suspension trauma.

In addition to being dangerous, it is rather uncomfortable to be suspended from an elevated position and held there by a safety harness. The human body is adapted to be supported upon its feet, not suspended by straps wrapped about the waist or upper thighs. In a relatively short length of time, these straps can become painfully uncomfortable.

Conventional devices for alleviating the discomfort associated with being suspended in midair in a harness and for minimizing suspension trauma are rather cumbersome to use and difficult to deploy. Accordingly, there exists in the industry a need for an effective, easy to use, and easy to deploy safety device that alleviates discomfort and that reduces suspension trauma to a person suspended in midair. It is to the provision of such that the present invention is primarily directed.

### SUMMARY OF THE INVENTION

Briefly described, in an illustrative form the present invention is a safety device for minimizing suspension trauma to a user suspended in a harness in an elevated position. The safety device includes a strap for providing a foothold for the user's feet and a sliding loop for adjusting the length of the strap. A first end of the strap is attached to the user's harness at a first side, and the sliding loop is attached to the user's harness at an opposite side. The sliding loop is freely movable along the strap when not loaded, but resists movement relative to the strap when under load. Preferably, the sliding loop comprises a knotted length of rope having a prusik knot. The sliding loop can be releasably connected to the user's harness with a clip or a carabiner. Also, the safety device can further include a pouch coupled to user's harness for storing the safety device when not in use.

In another form, the present invention is a method for preventing injury to a person suspended by a safety harness after a fall from an elevated position. The method includes the steps of securing a first end of a suspension relief device to the user's safety harness, wherein the safety device comprises a strap having a sliding rope coupler attached thereto, using the sliding rope coupler to adjust the length of the suspension relief device, attaching the sliding rope coupler to the user's safety harness, and positioning the user's feet on a portion of the strap. Preferably, the sliding rope coupler comprises a prusik hitch for grabbing against the strap to lock to the sliding rope coupler to the strap.

In yet another form, the present invention is a safety system for preventing suspension trauma. The safety system includes a safety harness for engaging a wearer, a standing line for attachment to a support structure, and a suspension relief device. The suspension relief device includes a strap for providing a foothold for the user's feet and a sliding rope coupler for adjusting the length of the strap, wherein a first end of the strap is attached to the user's harness at a first side and the sliding rope coupler is attached to the user's harness at an opposite side. Thus, the sliding rope coupler can freely move along the strap when not loaded, but resists movement relative to the strap when under load. Preferably, the first end of the sliding rope coupler is releasably attached to the safety harness such as with a carabiner or a clip.

Advantageously, the safety device of the present invention provides an easy to use foothold for preventing venous pooling and suspension trauma after a fall from an elevated position. When not in use, the safety device is stored compactly in a pouch that is attached to the user's harness at a point near one of the user's hips. After a fall from an elevated position, the user simply opens the pouch, adjusts the length of the strap using a sliding rope coupler, and clips the carabiner or clip to a D-ring on the opposite side of the harness to provide a foothold for the user's feet. Thus, the user can prevent adverse health effects, as well as discomfort, by standing on the foothold and contracting his leg muscles while waiting to be rescued.

### BRIEF DESCRIPTION OF THE DRAWINGS

FIG. 1 is a perspective view of a suspension relief device according to an example embodiment of the present invention.

FIGS. 2A-2F schematically demonstrate the tying of a prusik knot of the suspension relief device of FIG. 1.

FIG. 3 is a perspective view of a pouch for containing the suspension relief device of FIG. 1.

FIG. 4 is a perspective view of the suspension relief device of FIG. 1 in use.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

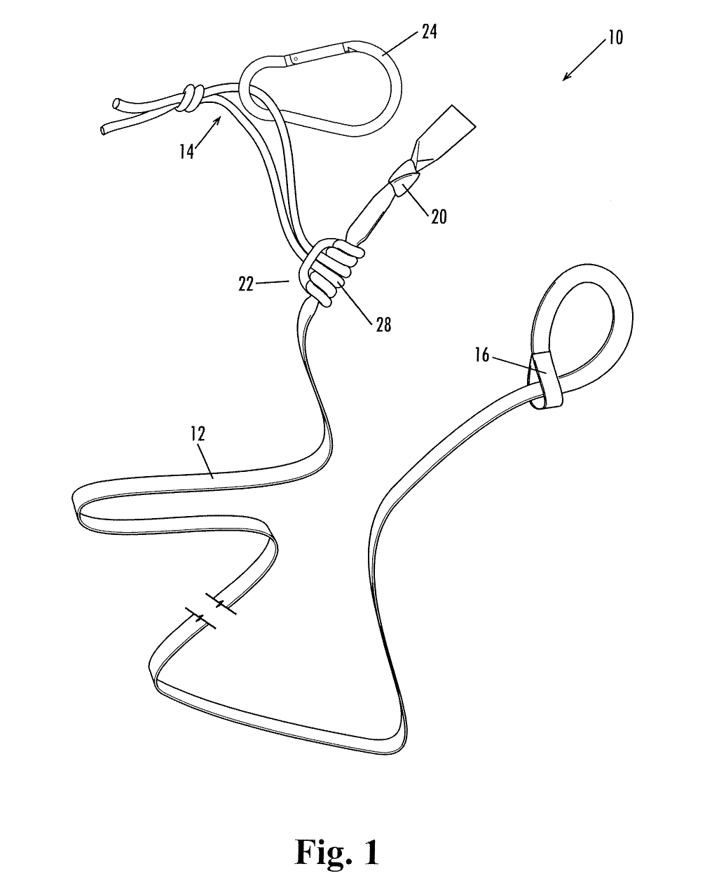

FIG. 1 is a perspective view of a safety device or suspension relief device 10 according to an example embodiment of the present invention. The suspension relief device 10 typically would be used only after a user falls from an elevated position and is suspended by a fall arrest system (e.g., a safety harness or a safety line). The suspension relief device 10 alleviates pressure and blood accumulating in the legs by providing a foothold to support muscle pumping in the legs.

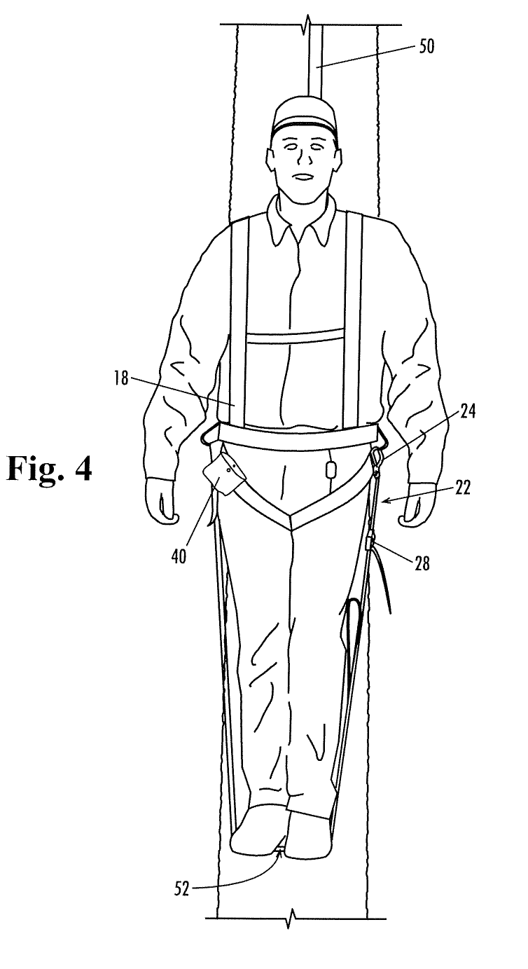

As shown in FIG. 1, the suspension relief device 10 includes a strap 12 of a durable material having an adjustment member 14 slidably coupled thereto. A loop 16 is located at a first end of the strap 12 for attachment to a user's harness 18, as shown more clearly in FIG. 4. Those skilled in the art will understand that the strap 12 can include various other durable fasteners, such as a carabiner or linesman's clip, to attach the strap to the user's harness. Alternatively, the first end of the strap 12 can be permanently or semi-permanently attached or affixed to the harness, such as by sewing, gluing, or bonding. A knot 20 is located at a second end of the strap 12 for providing a mechanical stop for the adjustment member 14. Alternatively, other mechanical stops can be used. Preferably, the strap 12 is constructed of a durable fabric, such as a conventional nylon or a high strength web material. Alternatively, the strap 12 can be a length of rope, chain, or the like. In the depicted embodiment, the strap 12 is about an inch wide by about 80-90 inches long, though those skilled in the art will understand that the length of the strap can be longer or shorter and the width can be wider or narrower and still be within the scope of the present invention.

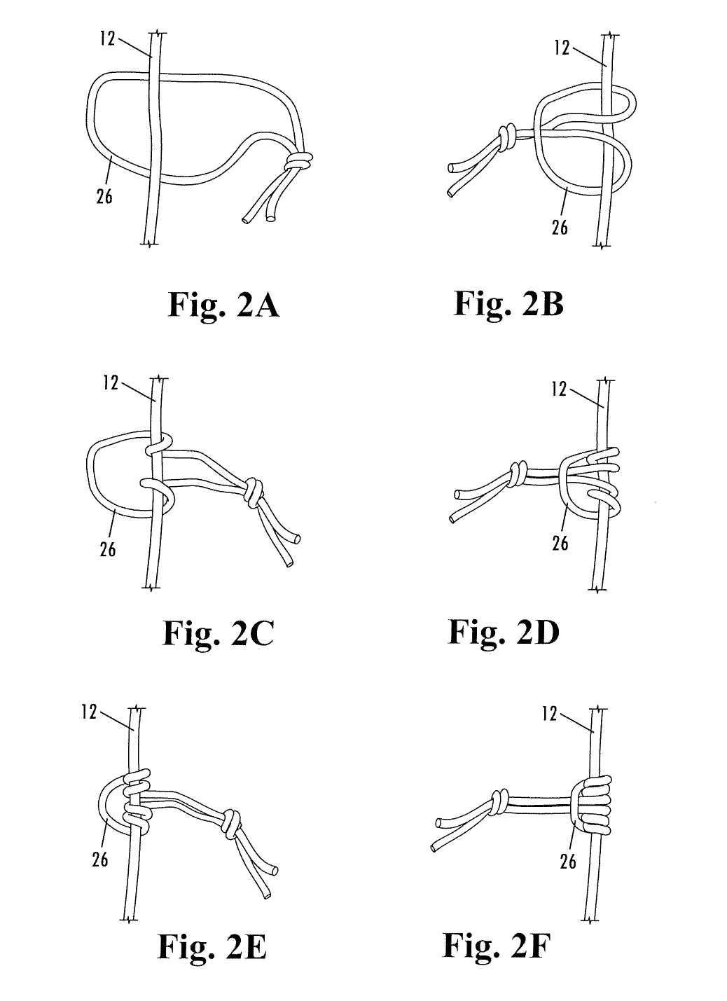

The adjustment member 14 includes a sliding loop 22 slidably coupled to the strap 12. Preferably, the sliding loop 22 includes a clip 24, such as a carabiner or linesman's clip, attached thereto. The sliding loop 22 is preferably slidable along at least a portion of the length of the strap 12, and is freely movable along the strap when not loaded, but resists movement relative to the strap when under load. In this manner, the user can freely adjust the position of the sliding loop 22 along the strap prior to applying a load, that is the user's weight, to the strap. Under the load of the user's weight, the sliding loop 22 is locked into place and will not slide along the strap 12. In a typical commercial embodiment as depicted in the figures, the sliding loop 22 is preferably a knotted length of rope 26. In alternate embodiments, the sliding loop 22 can comprise a mechanical, electromechanical or magnetic device permitting movement along the strap 12 when unloaded, but resisting movement relative to the strap when under load. The rope 26 forming the sliding loop 22 can comprise a length of 3,000-pound test polyester rope, although those skilled in the art will understand that other types of rope can be used as well. In a preferred embodiment of the invention, the sliding loop 22 comprises a loop of rope 26 of about twenty-four inches or so long tied into a prusik knot 28, as shown in FIGS. 1-2. In alternate embodiments, other sliding loop knots, such as for example, a Kleimheist knot, a Blake's hitch, or a Kreutzklem knot may be used to form the sliding loop 22.

Those skilled in the art will understand that the length of the suspension relief device 10 includes the length of the strap 12 plus the length of the sliding loop 22. Thus, the combined length of the strap 12 and the sliding loop 22 is preferably at least as long as twice the outseam of the user, although those skilled in the art will understand that the length of the device 10 can vary and still function for its intended purpose of providing a foothold to reduce venous pooling.

FIGS. 2A-2F schematically demonstrate the tying of the prusik knot 28. The sliding loop 22 is formed of a smaller diameter rope than the strap 12. A bight of the rope 26 is placed over the strap 12, as shown in FIG. 2A. The rope 26 is wrapped once around the strap 12 as shown in FIG. 2B, wrapped again around the strap as shown in FIG. 2C, and wrapped a third time around the strap as shown in FIG. 2D. The rope 26 is pulled to tighten and tidy the coils of the knot, as shown in FIG. 2E, to form the sliding loop 22. The sliding loop 22 slides freely along the strap 12 in the unloaded configuration shown in FIG. 2E. When a load F is applied to the sliding loop 22, however, the prusik knot 28 tightens as shown in FIG. 2F, and resists movement along the strap 12.

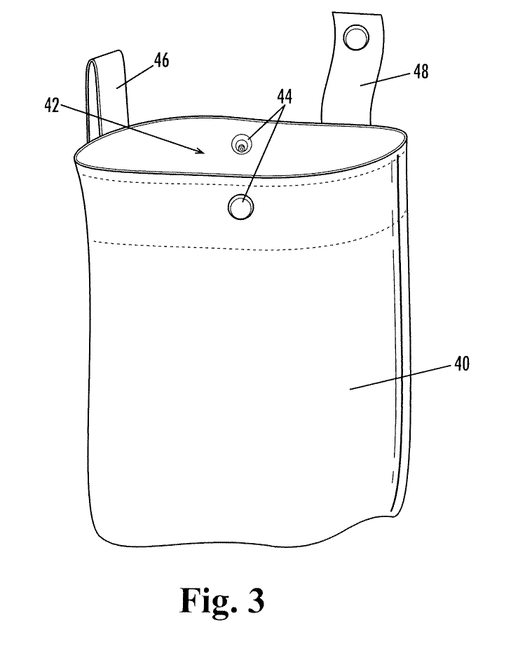

As shown in FIGS. 3 and 4, the entire suspension relief device 10 can be stored compactly in a pouch 40 that can attach to the user's harness 18 or belt. Preferably, the pouch 40 is large enough to accommodate the entire suspension relief device 10, but no so large that it becomes bulky or inconvenient to the user of the safety device. In the depicted embodiment, the pouch 40 has dimensions of about five inches long by about four inches wide by about one inch deep. However, those skilled in the art will understand that the pouch can be constructed of any suitable size. Preferably, the pouch 40 has a closure 42 for securely containing the suspension relief device 10 therein. As shown in FIG. 3, the closure 42 is a single snap 44, although those skilled in the art will understand that any fastening or closure device, such as for example a button, zipper, hook and loop material, or tie, can be used as the closure 42. Additionally, any number of closures or fastening devices can be used and still be within the scope of the present invention. Preferably, the pouch 40 also includes one or more fastening straps 46 for releasably attaching the pouch to the harness 18 or belt worn by the user. As shown in the depicted embodiment, two fastening straps 46 and 48 with snaps on ends thereof are used to fasten the pouch around a belt strap or ring of the user's harness 18. Those skilled in the art will understand that various fasteners and fastening methods can be used to secure the pouch 40 to the harness without deviating from the scope of the present invention. For example, the pouch 40 can comprise a tie, clip, snap, or other fasteners to removably attach the pouch to the hunter's harness. Alternatively, the pouch 40 can be permanently or semi-permanently attached to a harness, such as by sewing, gluing, or bonding. Also, the pouch 40 can be constructed of a camouflage fabric so as to blend in with the outerwear of a hunter.

In use, the suspension relief device 10 is initially contained within its pouch 40 such that the loop 16 of the strap 12 is easily accessed. The strap 12 is securely connected to the user's harness 18 (or belt) by placing the loop 16 of the strap behind a belt strap of the user's harness 18 or through a D-ring of the harness, preferably located at or near the user's hip. The pouch 40 is then inserted through the loop 16, and the strap 12 is pulled taught so that the loop end of the strap is securely attached to the harness 18. Alternatively, the user can attach the suspension relief device 10 to his harness 18 by sliding the loop 16 of the device through a D-ring or behind a strap of the harness and inserting the sliding loop 22 of the device through the end loop 16 of the device and pulling the strap taut. The suspension relief device 10 can then be rolled up and tucked into the pouch 40. The pouch 40 is attached to the user's harness 18 by looping the straps 46 and 48 around a belt of the harness and fastening the ends together. Any excess strap 12 can be tucked into the pouch 40, and the pouch can be closed shut with the closure 42.

In the event of a fall from an elevated position, the user's fall arrest system, such as the safety line 50 as shown in FIG. 4, prevents him from falling to the ground. Thus, the user is suspended midair. While suspended, the user simply opens the pouch 40 and removes the suspension relief device 10. Notably, the loop end of the suspension relief device 10 has already been attached to the user's harness. The user attaches the clip 24 or the carabiner to a D-ring or belt on the harness 18. The user adjusts the length of the strap 12 by adjusting the sliding loop 22 such that the adjusted length of the strap in combination with the length of the sliding loop 22 is long enough to extend from its attachment point at the user's hip downwardly to the user's feet and back upwardly to the harness for attachment at the opposite hip. Preferably, the strap 12 is adjusted with the sliding loop 22 so that it is a littler longer than approximately twice the length of the user's outseam measurement (so as to account for the widths of the user's feet). Thus, when the user stands on the strap 12, as shown in FIG. 4, the sliding loop 22 with the prusik hitch 28 resists movement relative to the strap 12 when under the weight of the user. The strap 12 functions as a foothold 52 so that the user can stand on it and thus support the weight of his body with his feet. If the strap 12 is too long, then the user will not be able to stand on the strap. If the strap 12 is too short, the user simply bends his knees such that he can press his feet against the strap. In such situation, the user can still receive the benefit of alleviating venous pooling and discomfort by pressing his feet against the strap, even though his knees are bent.

While the invention has been described with reference to example embodiments, it will be understood by those skilled in the art that a variety of modifications, additions and deletions are within the scope of the invention, as defined by the following claims.

What is claimed is:

1. A safety device for minimizing suspension trauma to a user suspended in a harness in an elevated position, comprising:
a strap for providing a foothold for the user's feet; and
a sliding loop for adjusting the length of the strap, wherein a first end of the strap is attached to the user's harness at a first side and the sliding loop is attached to the user's harness at an opposite side, whereby the sliding loop is freely movable along the strap when not loaded, but resists movement relative to the strap when under load.

2. The safety device of claim 1, wherein the sliding loop further comprises a knotted length of rope.

3. The safety device of claim 2, wherein the knotted length of rope has a smaller diameter than the strap.

4. The safety device of claim 2, wherein the sliding loop further comprises a clip for releasable attachment to the user's harness.

5. The safety device of claim 2, wherein the sliding loop further comprises a carabiner for releasable attachment to the user's harness.

6. The safety device of claim 2, wherein the sliding loop further comprises a prusik knot.

7. The safety device of claim 2, wherein the sliding loop further comprises one of a Kleimheist knot, a Blake's hitch, or a Kreutzklem knot.

8. The safety device of claim 1, further comprising a pouch coupled to user's harness for storing the safety device when not in use.

9. The safety device of claim 1, wherein the strap further comprises a loop at an end thereof or attachment to the user's harness.

10. A method for preventing injury to a person suspended by a safety harness after a fall from an elevated position, the method comprising the steps of:
securing a first end of a suspension relief device to the user's safety harness, wherein the suspension relief device comprises a strap having a sliding rope coupler attached thereto;
using the sliding rope coupler to adjust the length of the suspension relief device;
attaching the sliding rope coupler to the user's safety harness; and
positioning the user's feet on a portion of the strap.

11. The method of claim 10, wherein the sliding rope coupler comprises a prusik hitch for grabbing against the strap to lock to the sliding rope coupler to the strap.

12. A safety system for preventing suspension trauma, comprising:
a safety harness for engaging a wearer;
a standing line for attachment to a support structure; and
a suspension relief device having a strap for providing a foothold for the user's feet and a sliding rope coupler for adjusting the length of the strap, wherein a first end of the strap is attached to the user's harness at a first side and the sliding rope coupler is attached to the user's harness at an opposite side, whereby the sliding rope coupler is freely movable along the strap when not loaded, but resists movement relative to the strap when under load.

13. The safety system of claim 12, wherein the first end of the sliding rope coupler is releasably attached to the safety harness.

14. The safety system of claim 13, wherein the sliding loop further comprises a carabiner or a clip for releasably securing the sliding rope coupler to the safety harness.

15. The safety system of claim 12, wherein the first end of the sliding rope coupler is permanently or semi-permanently affixed to the safety harness.
